(19) United States
(12) Patent Application Publication
(10) Pub. No.: US 2023/0204364 A1
(43) Pub. Date: Jun. 29, 2023

(54) ASCERTAINING A STARTING POSITION OF A VEHICLE FOR A LOCALIZATION

(71) Applicant: Robert Bosch GmbH, Stuttgart (DE)

(72) Inventors: Timo Nachstedt, Benningen (DE); Georg Krause, Ludwigsburg (DE); Renlin Li, Heilbronn (DE)

(21) Appl. No.: 17/998,593

(22) PCT Filed: Jun. 14, 2021
(86) PCT No.: PCT/EP2021/065895

§ 371 Date: Nov. 11, 2022

(30) Foreign Application Priority Data
Jun. 30, 2020 (DE) 10 2020 208 082.8

(51) Int. Cl. G01C 21/30; G01C 21/36; G06T 7/73

(52) U.S. Cl. CPC G01C 21/30; G01C 21/3602; G06T 7/74; B60W 60/001

(57) ABSTRACT

A method for ascertaining a starting position of a vehicle for a localization of the vehicle using a control unit. In the method, measurement data are received from an odometry sensor system and/or a GNSS sensor system of the vehicle, a first position and an uncertainty range of the first position are determined based on the measurement data received, at least one map section of a feature map containing a plurality of stored features is received, the map section having a position and extent which is superimposed on the first position and the uncertainty range, measurement data are received from a LiDAR sensor system, a radar sensor system and/or a camera sensor system and static features are extracted from the measurement data received, a first starting position of the vehicle is ascertained by comparing the static features extracted from measurement data with features stored in the map section.

### FIELD

The present invention relates to a method for ascertaining a starting position of a vehicle for a localization of the vehicle. The present invention further relates to a method for performing a localization, a control unit, a computer program, and a machine-readable storage medium.

### BACKGROUND INFORMATION

In order for lane-level digital maps to be used, the vehicle must be able to determine its own position with lane-level precision. The position of the vehicle may be ascertained by way of a localization. Localizing the vehicle position requires a precise initial position or starting position, since localization is generally based on iterative processes. Measurement data from an odometry sensor system, for example, are used here to determine the vehicle position based on the initial position.

Methods for determining an initial position for vehicle localization based on the receipt of GNSS data are described in the related art. A plurality of GNSS positions may be used here to determine an initial position. However, in many road sections, such as woods or tunnels, for example, the GNSS signals from corresponding satellites that are needed for these methods are not available. The insufficient accuracy of the ascertained GNSS positions constitutes a further problem.

To improve the accuracy of the ascertained GNSS positions, differential methods may be used, although the additional hardware involved means that they are expensive and not available everywhere.

### SUMMARY

A problem addressed by the present invention may be considered that of proposing a precise method for ascertaining an initial position or starting position for an iterative vehicle localization, which may be implemented with inexpensive sensors.

This problem may be solved by the present invention. Advantageous example embodiments of the present invention are disclosed herein.

According to one aspect of the present invention, a method is provided for ascertaining a starting position of a vehicle for a localization of the vehicle by way of a control unit. In particular, the method may be performed by an initialization module of the control unit in the form of hardware and/or software.

According to an example embodiment of the present invention, in one step, measurement data are received from an odometry sensor system and/or from a GNSS sensor system of the vehicle. To this end, the odometry sensor system and/or GNSS sensor system may be connected to the control unit for data transfer.

Based on the measurement data received, a first position and an uncertainty range of the first position are determined. In a further step, at least one map section of a feature map containing a plurality of stored features is received. The map section preferably has a position and extent which is superimposed on the first position and the uncertainty range of the first position. The uncertainty range may take the form of an ellipse, a circle or a polygon. The position may be located in the center of the uncertainty range or off-center.

In a further step, measurement data from a LiDAR sensor system, a radar sensor system and/or a camera sensor system are received, and static features are extracted from the measurement data received. Such static features may represent static objects, such as buildings, road boundaries, road markings, trees, street signage, the course of the road, and the like. The static features may take the form of a signature or a characteristic measurement data grid.

A starting position of the vehicle is then ascertained by comparing the static features extracted from the measurement data with features stored in the map section.

The method may be used to ascertain a lane-level initial position or starting position of the vehicle, which serves as the basis for an iterative localization process. The starting position may also take the form of a starting pose with a position and orientation of the vehicle.

By limiting the map section to a small region around the first position and its uncertainty range, it is possible to conduct a feature comparison with minimal technical effort. The requirements in terms of sensor accuracy are low, so even inexpensive sensors may be used for the method.

According to an example embodiment of the present invention, the option to use a radar sensor system allows the starting position to be determined even in poor weather conditions, such as rain or fog. Moreover, the starting position may be ascertained accurately even in areas with no GNSS signal.

In particular, the starting position may be used to implement automated or partially automated driving functions. Such driving functions may use lane-level navigation, for example, and may include trajectory planning.

According to an example embodiment of the present invention, the method for ascertaining the starting position is determined substantially by way of three main steps. In one step, measurement data from the odometry sensor system and/or the GNSS sensor system of the vehicle are used separately or as a fusion of sensor data to determine the first position. Based on the first position, a corresponding map section may be loaded, covering the first position and its uncertainty range. In a third main step, the loaded map section may be used for a feature-based localization, drawing on measurement data from a LiDAR sensor system, a radar sensor system and/or a camera sensor system.

According to a further aspect of the present invention, a control unit is provided, the control unit being set up to perform the method(s) disclosed herein. The control unit may be, for example, an on-board control unit, an off-board control unit or an off-board server unit, such as a cloud system, for example.

In particular, the control unit may have a localization module and/or an initialization module. The control unit is thus able to carry out the method to ascertain the starting position of a vehicle and/or the method to perform a localization.

Moreover, according to one aspect of the present invention, a computer program is provided, which comprises commands that cause a computer or a control unit running the computer program to carry out the method according to the present invention. According to a further aspect of the present invention, a machine-readable storage medium is provided, on which the computer program according to the present invention is stored.

The vehicle may be operated in an assisted, partially automated, highly automated and/or fully automated or driverless manner, as defined by the German Federal Highway Research Institute (BASt) standard.

The vehicle may be, for example, a passenger car, a truck, a driverless taxi and the like. The vehicle is not limited to operating on roads. Rather, the vehicle may also be designed as a watercraft, aircraft, such as a transport drone, for example, and the like.

In a further specific example embodiment of the present invention, at least one second starting position, temporally separated from the first starting position, is ascertained, the first starting position and the at least one second starting position being compared with positions ascertained from measurement data from the odometry sensor system. Preferably, a deviation is calculated between the at least one second starting position and a position of the vehicle ascertained by way of measurement data from the odometry sensor system, and a consistency check is carried out. This consistency check may be performed as a final step of the method to ensure reliable initialization results. In particular, in periodic environments such as a wooded section or a freeway, for example, with a plurality of identical road boundaries or static features, this consistency check may ensure that the starting position is correct.

The technical implementation of the consistency check may be achieved particularly easily if the first of the two successive orientation results or starting positions is propagated using measurement data from the odometry sensor system up to the time of the second orientation result, and the difference from the actual second orientation result is then calculated. If the difference is below a certain threshold, the starting position may be considered to be consistent.

In an advantageous embodiment of the present invention, a plurality of consistent starting positions may be ascertained in succession before the starting position is transferred to the vehicle localization system.

According to a further exemplary embodiment of the present invention, at least one second starting position, temporally separated from the first starting position, is ascertained, the first starting position and the at least one second starting position being combined with measurement data from the odometry sensor system to form trajectories. A goodness of fit is ascertained for each trajectory, a trajectory with the best goodness of fit being used or all trajectories being rejected. If the starting positions are rejected, then the method is carried out again in order to ascertain a starting position that passes the consistency check. Multi-hypothesis tracking may thus be used. The accuracy of the starting position, especially in periodic environments, may be further increased by this measure.

According to a further specific embodiment of the present invention, extracted static features from prior measurements by the LiDAR sensor system, the radar sensor system and/or the camera sensor system are used to compare the extracted features with features stored in the map section. The map section may be enlarged in this case, according to the gap between a current measurement and the prior measurement. This may be achieved using measurement data from the odometry sensor system. The prior measurement data and the current measurement data may preferably include spatially separated static features which, combined with the features stored in the map section, may be compared in order to ascertain the first starting position. A larger data cloud may thus be utilized to ascertain the first starting position. This measure may replace the consistency check, for example.

According to a further exemplary embodiment of the present invention, the extracted features from the prior measurements are linked to the extracted features from current measurements using measurement data from the odometry sensor system. The prior static features, ascertained a few seconds earlier, for example, may thus be combined with currently ascertained static features over the distance covered by the vehicle. The distance covered by the vehicle may be tracked by the odometry sensor system. This enables an enlarged road geometry with corresponding features to be used to resolve a lack of clarity or ambiguities in periodic environments, such as freeways or wooded sections, for example.

According to a further specific embodiment of the present invention, an optimization method is used to determine the first position. For example, a data structure may be created on the basis of a sliding graph with measurement data from the odometry sensor system and the GNSS sensor system of the vehicle received over a period of time and used to ascertain the first position. Measurement uncertainties, variations and jitter when determining the first position may be eliminated or reduced by this measure.

According to a further exemplary embodiment of the present invention, the measurement data from the odometry sensor system and/or the GNSS sensor system of the vehicle are received continuously. Furthermore, the first position is determined continuously on the basis of the measurement data received. The availability of the first position for ascertaining the first starting position may be ensured by this measure.

According to a further specific embodiment of the present invention, the ascertained starting position is used to perform a road approval service. The method may thus be used to approve a road or a road section for certain automated or partially automated driving assistance functions. Here, through the redundant use of the measurement data from the odometry sensor system and the static features, a manipulation of the starting position, by so-called GNSS spoofing, for example, may be prevented.

According to a further aspect of the present invention, a method is provided for performing a localization, wherein a first starting position ascertained by a method according to the present invention for ascertaining a starting position of a vehicle is received as an input variable and/or as a validation variable.

Using the ascertained starting position, lane-level localization of a vehicle to a digital map is achievable even with inexpensive vehicle sensors. The method for performing the localization may provide a continuous comparison of static features from measurement data from a LiDAR sensor system, a radar sensor system and/or a camera sensor system of the vehicle with features stored in the digital map. This may be done using a localization module of the control unit, for example. Since the method for performing the localization is iterative, the provision of the precise starting position ensures that the vehicle is localized with particular accuracy.

In particular, the first position enables the search range for the feature-based localization to be limited to the at least one map section and the computational demand to be reduced.

According to a specific embodiment of the present invention, the method for ascertaining the starting position or initial position is carried out in parallel with the method for performing the localization. This measure enables the initialization module of the control unit to run in the background during the localization. In this way, the output of the initialization module may be used as an additional status check for the localization output. If a difference is identified between the starting position and the vehicle position ascertained by localization that exceeds a limit value, a new starting position may be output for the localization module and the vehicle localization is started again.

Preferred exemplary embodiments of the present invention are described in greater detail below by reference to highly simplified schematic representations in the figures.

### BRIEF DESCRIPTION OF THE DRAWINGS

FIG. 1 shows a schematic top view of a roadway to illustrate a determination of a first position of a vehicle in accordance with an example embodiment of the present invention.

FIG. 2 shows a schematic top view of a roadway from FIG. 1 and of a map section,

FIGS. 3, 4 show schematic diagrams to illustrate a consistency check, according to an example embodiment of the present invention.

### DETAILED DESCRIPTION OF EXAMPLE EMBODIMENTS

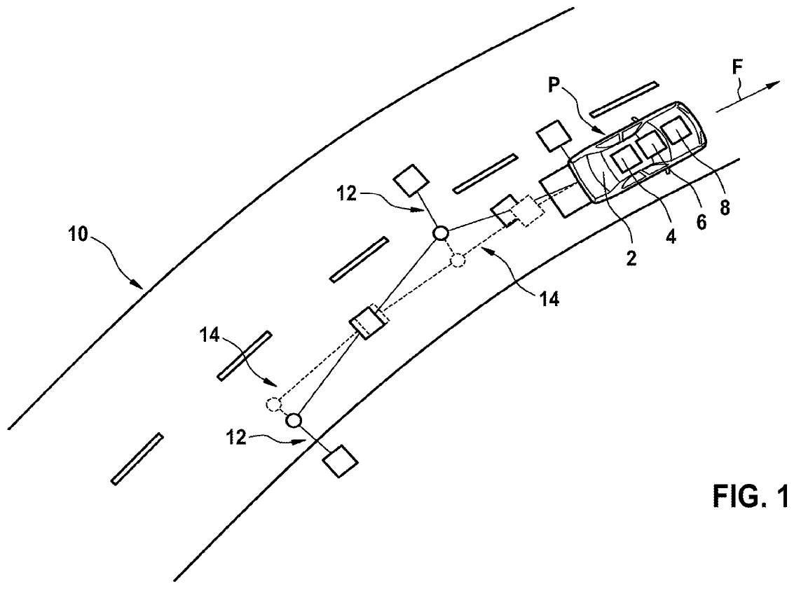

FIGS. 1 through 4 show schematic representations to illustrate a method for ascertaining a first starting position A of a vehicle 2 for a localization of vehicle 2 by a control unit 4.

Vehicle 2 has an odometry sensor system and/or a GNSS sensor system 6 as well as an additional sensor system 8 for a feature-based localization. Additional sensor system 8 may be designed as, for example, a LiDAR sensor system, a radar sensor system and/or a camera sensor system.

FIG. 1 shows a schematic top view of a roadway 10 to illustrate a determination of a first position P of vehicle 2. Vehicle 2 travels along roadway 10 in direction of travel F. In the exemplary embodiment shown, measurement data are collected during the journey by the odometry sensor system and GNSS sensor system 6. In this process, a plurality of measurement data 12 collected in chronological succession by the odometry sensor system and GNSS sensor system 6 are stored in order to determine first position P. Measurement data 12 from the odometry sensor system and GNSS sensor system 6 may optionally be smoothed so as to obtain optimized measurement data 14 from the ascertained measurement data 12. The ascertained measurement data 12 may be optimized by way of moving averages, for example.

There may be a maximum limit set for the amount of measurement data 12 ascertained, such that old measurement data are deleted automatically or overwritten by more recent measurement data. First position P may in this case be the last or most recent measurement by the odometry sensor system and GNSS sensor system 6 following optimization or smoothing.

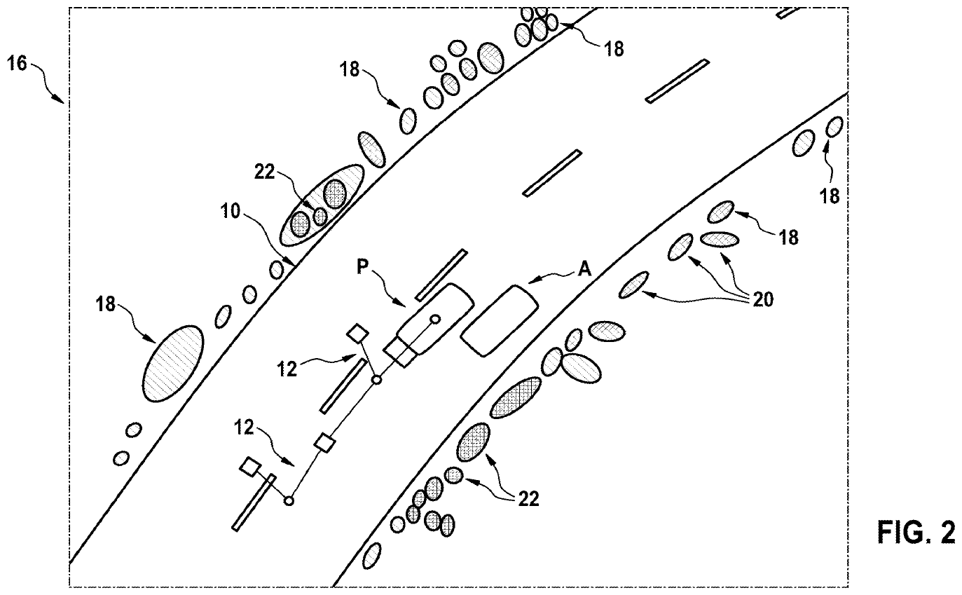

FIG. 2 shows a schematic top view of a roadway 10 from FIG. 1 and of a map section 16. Map section 16 is part of a feature map and contains a plurality of features 18. In the exemplary embodiment shown, the feature map is a radar-specific feature map. Map section 16 has a position and an extent which is superimposed on or covers first position P and an optional uncertainty range of first position P.

Furthermore, extracted static features 20 from current measurements and static features 22 from prior measurements by the LiDAR sensor system, the radar sensor system and/or camera sensor system 8 are taken into account, such that an enlarged map section 16 is used to compare extracted static features 20, 22 with features 18 stored in map section 16.

The radar-specific feature map and map section 16 are stored in the form of map sections 16 which map the topology of the road network or of roadway 10. The at least one map section 16 may be transformed into a coordinate system for vehicle 2, which in the interests of clarity is not shown in FIG. 2. Furthermore, features 18 of map section 16 may be compared with the extracted static features 20, 22 and aligned with one another for a feature-based localization. Such an alignment may be carried out with a cost function and an optimization algorithm for the cost function.

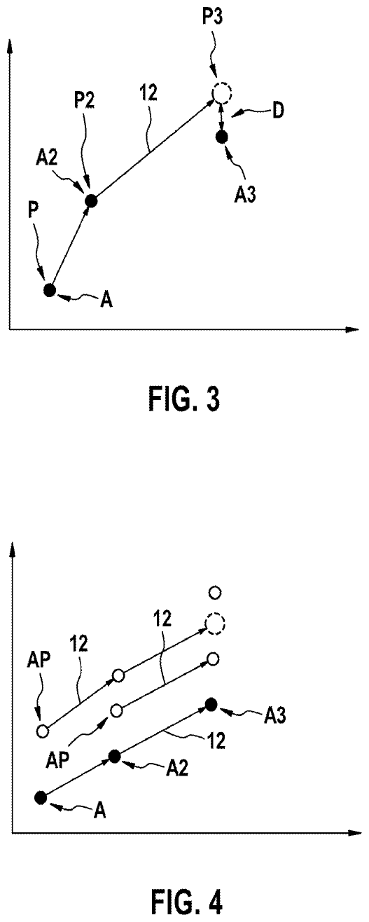

FIG. 3 and FIG. 4 show schematic diagrams to illustrate a consistency check. FIG. 3 shows a technically simplified consistency check. A plurality of second starting positions A2, A3, temporally separated from first starting position A, are ascertained.

In parallel with starting positions A, A2, A3, positions P, P2, P3 are ascertained using odometry sensor system 6 and compared with starting positions A, A2, A3. To this end, a difference D or a gap between positions P, P2, P3 and starting positions A, A2 may be calculated. The consistency check is successful if difference D is below a predefined threshold or limit.

In the exemplary embodiment shown, the first two starting positions A, A2 are consistent and correct. The last starting position A3 exhibits too great a deviation D from position P3 and is not consistent. In this case, the method for ascertaining the starting position A of vehicle 2 may be carried out again and subjected to a consistency check. By preference, the consistency check may present a number of successfully checked starting positions A, A2, A3 before the most recently checked starting position A3 is approved for a localization of vehicle 2.

FIG. 4 illustrates a technically more complex consistency check, which is based on multi-hypothesis tracking. A plurality of starting positions A, A2, A3 with a best match within map section 16 are taken into consideration. These starting positions A, A2, A3 are linked to matches from the last alignment of features 18, 20, 22. Measurement data 12 from odometry sensor system 6 are used to join starting positions A, A2, A3. Each of starting positions A, A2, A3 may have parallel starting positions AP within map section 16 at which extracted features 20, 22 match features 18 stored in map section 16. Such results of the feature-based localization may occur in periodic environments, such as freeway sections, for example. Measurement data 12 from odometry sensor system 6 are compared in the form of trajectories with respective starting positions A, A2, A3, AP, starting positions A, A2, A3, AP having the best goodness of fit being used for the further localization of vehicle 2.

1-13. (canceled)

14. A method for ascertaining a starting position of a vehicle for a localization of the vehicle, by a control unit, the method comprising the following steps:
receiving measurement data from an odometry sensor system of the vehicle and/or from a GNSS sensor system of the vehicle;
determining, based on the measurement data received from the odometry sensor system and/or the GNSS sensor system, a first position and an uncertainty range of the first position;
receiving at least one map section of a feature map containing a plurality of stored features, the map section having a position and extent which is superimposed on the first position and the uncertainty range;
receiving measurement data from a LiDAR sensor system and/or a radar sensor system and/or a camera sensor system, and extracting static features from the measurement data received from the LiDAR sensor system, and/or the radar sensor system and/or the camera sensor system; and
ascertaining a first starting position of the vehicle by comparing the extracted static features with features stored in the map section.

15. The method as recited in claim 14, wherein at least one second starting position, temporally separated from the first starting position, is ascertained, the first starting position and the at least one second starting position being compared with positions ascertained from measurement data from the odometry sensor system, a deviation being calculated between the at least one second starting position and a position of the vehicle ascertained using the measurement data from the odometry sensor system, and a consistency check is carried out.

16. The method as recited in claim 14, wherein at least one second starting position, temporally separated from the first starting position, is ascertained, the first starting position and the at least one second starting position being combined with measurement data from the odometry sensor system to form trajectories, a goodness of fit being ascertained for each of the trajectories, a trajectory with a best goodness of fit being used or all trajectories being rejected.

17. The method as recited in claim 14, wherein extracted static features from prior measurements by the LiDAR sensor system and/or the radar sensor system and/or the camera sensor system are used to compare the extracted features with features stored in the map section.

18. The method as recited in claim 17, wherein extracted static features from the prior measurements are linked to the extracted static features from current measurements using measurement data from the odometry sensor system.

19. The method as recited in claim 14, wherein an optimization method is used to determine the first position.

20. The method as recited in claim 14, wherein the measurement data from the odometry sensor system and/or the GNSS sensor system of the vehicle are received continuously and the first position is determined continuously based on the measurement data received from the odometry sensor system and/or the GNSS sensor system of the vehicle.

21. The method as recited in claim 14, wherein the ascertained starting position is used to perform a road approval service.

22. A method for performing a localization, the method comprising the following steps:
receiving a first starting position of a vehicle as an input variable and/or as a validation variable, the first starting position being ascertained by:
receiving measurement data from an odometry sensor system of the vehicle and/or from a GNSS sensor system of the vehicle,
determining, based on the measurement data received from the odometry sensor system and/or the GNSS sensor system, a first position and an uncertainty range of the first position,
receiving at least one map section of a feature map containing a plurality of stored features, the map section having a position and extent which is superimposed on the first position and the uncertainty range,
receiving measurement data from a LiDAR sensor system, and/or a radar sensor system and/or a camera sensor system, and extracting static features from the measurement data received from the LiDAR sensor system, and/or the radar sensor system and/or the camera sensor system, and
ascertaining a first starting position of the vehicle by comparing the extracted static features with features stored in the map section.

23. The method as recited in claim 22, wherein the ascertaining of the starting position is carried out in parallel with the method for performing the localization.

24. A control unit configured to ascertain a starting position of a vehicle for a localization of the vehicle, by a control unit, the control unit configured to:
receive measurement data from an odometry sensor system of the vehicle and/or from a GNSS sensor system of the vehicle;
determine, based on the measurement data received from the odometry sensor system and/or the GNSS sensor system, a first position and an uncertainty range of the first position;
receive at least one map section of a feature map containing a plurality of stored features, the map section having a position and extent which is superimposed on the first position and the uncertainty range;
receive measurement data from a LiDAR sensor system and/or a radar sensor system and/or a camera sensor system, and extracting static features from the measurement data received from the LiDAR sensor system and/or the radar sensor system and/or the camera sensor system; and
ascertain a first starting position of the vehicle by comparing the extracted static features with features stored in the map section.

25. A non-transitory machine-readable storage medium on which is stored a computer program for ascertaining a starting position of a vehicle for a localization of the vehicle, by a control unit, the computer program, when executed by a computer, causing the computer to perform the following steps:
receiving measurement data from an odometry sensor system of the vehicle and/or from a GNSS sensor system of the vehicle;
determining, based on the measurement data received, a first position and an uncertainty range of the first position;
receiving at least one map section of a feature map containing a plurality of stored features, the map section having a position and extent which is superimposed on the first position and the uncertainty range;
receiving measurement data from a LiDAR sensor system and/or a radar sensor system and/or a camera sensor system, and extracting static features from the measurement data received from the LiDAR sensor system, and/or the radar sensor system and/or the camera sensor system; and
ascertaining a first starting position of the vehicle by comparing the extracted static features with features stored in the map section.
